(19) United States
(12) Patent Application Publication
(10) Pub. No.: US 2008/0195450 A1
(43) Pub. Date: Aug. 14, 2008

(54) METHOD AND SYSTEM FOR MANAGING RESOURCES ON WIRELESS COMMUNICATION NETWORK

(75) Inventor: Sung-woo CHO, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/843,707

(22) Filed: Aug. 23, 2007

(30) Foreign Application Priority Data
Feb. 13, 2007 (KR) 10-2007-0014705

(51) Int. Cl. G06Q 10/00

(52) U.S. Cl. 705/8

(57) ABSTRACT

A resource management method and apparatuses for a communication system are provided. The resource management method provides an algorithm for resource cost optimization, which defines the first weight for higher resource-use rates, based on the channel state allocated to each customer node, and the second weight for improved fairness among users, based on a willingness of a user of each customer node to pay, calculates the resource cost for each customer node from the first and the second weights, and controls resource allocation for resource cost optimization.

### CROSS REFERENCE TO RELATED APPLICATIONS

This application claims priority from Korean Patent Application No. 10-2007-0014705, filed on Feb. 13, 2007, the disclosure of which is incorporated herein in its entirety by reference.

### BACKGROUND OF THE INVENTION

1. Field of the Invention

Methods consistent with the present invention relate to resource management for a communication system, and more particularly, to resource management which can efficiently distribute resources on a communication system to improve fairness and resource-use rates (also called “resource consumption rates”) among subscribers.

2. Description of the Related Art

In general, it is a matter of extreme delicacy to determine resource allocation and billing schemes for users of customer nodes in a communication system having a common node and a plurality of customer nodes for communication services. The users will be most satisfied when they are allocated the most resources with the minimum cost for the resources. In other words, a user will probably be most satisfied when the user is allocated from a service provider as many communication resources as the user's terminal can accommodate without paying any fee to the service provider.

However, such a situation is not realistic for two reasons: the service provider aims to maximize profits; and the above situation is contrary to the concept of fairness in resource use among users.

Accordingly, the service providers should exert themselves to improve the resource-use rates and the fairness in resource use among the users.

In particular, fairness is a major factor to users finding satisfaction in communication services since an unfair resource management system may lead to “user starvation”, which is caused by allocating a large part of resources to only a small minority of users.

Up to now, a flat sum system has been mainly adopted as a billing scheme for communication services. However, the flat sum system may be unfair to the users who feel discontented with the communication services offered to them in comparison with their payment for the services.

In order to overcome the above-mentioned problem, wired communication service providers have attempted to introduce a packet-rate system, which is advantageous both to the wired communication service providers and to the users.

However, the packet-rate system is not realistic in the wireless communication system since each user is allocated a different amount of resources to transmit a single packet in such a dynamic communication environment as wireless environment. Hence, it is difficult to guarantee fairness in the amount of resources which each user is allocated to transmit a single packet. Furthermore, the packet-rate system is contrary to the interests of the wireless communication service provider who aims to maximize a profit by transmitting more packets with lower amount of resource allocation.

### SUMMARY OF THE INVENTION

The present invention provides a method and system for managing resources, which is capable of increasing resource-use rates to allow service providers to maximize profits and of allocating the resources to users with improved fairness.

The present invention further provides a method for managing resources through a resource distribution algorithm which induces users to willingly increase the resource-use rates.

Additional aspects of the invention will be set forth in the description which follows, and in part will be apparent from the description, or may be learned by practice of the invention.

The present invention discloses a resource manager of a common node communicating with a customer node, including: a cost calculation unit to receive from the customer node a first weight based on a state of a channel allocated to the customer node and a second weight based on willingness to pay of a user of the customer node and to calculate resource cost for the customer node; and a resource allocation unit to receive from the customer node a resource allocation request for optimization of the resource cost and to allocate resources to the customer node.

The present invention also discloses a customer node communicating with a common node, including: a weight calculation unit to calculate a first weight based on a state of a channel allocated to the customer node, and a second weight based on willingness to pay of a user of the customer node, and to transmit the first and the second weights to the common node; and a resource request unit to receive from the common node a resource cost for the customer node calculated based on the first and the second weights, and to calculate the amount of resources required for optimization of the received resource cost and to request resources from the common node.

The present invention also discloses a resource manager of a common node communicating with a customer node, including: a cost calculation unit to receive from the customer node a first weight based on a state of a channel allocated to the customer node and a second weight based on willingness to pay of a user of the customer node and to calculate resource cost for the customer node; and a resource allocation unit to calculate the amount of resources required for the customer node for optimization of the resource cost and to allocate resources to the customer node.

The present invention also discloses a customer node communicating with a common node, including: a weight calculation unit to calculate a first weight based on a state of a channel allocated to the customer node, and a second weight based on willingness to pay of a user of the customer node, and to transmit the first and the second weights to the common node, where the customer node is allocated from the common node the amount of resources required for optimization of resource cost for the customer node calculated based on the first and the second weights.

The present invention also discloses a resource management method of a common node communicating with a customer node, including: receiving from the customer node a first weight based on a state of a channel allocated to the customer node and a second weight based on willingness to pay of a user of the customer node; calculating resource cost for the customer node based on the first and the second weights and transmitting the resource cost to the customer node; and receiving from the customer node a resource allocation request for optimization of the resource cost and allocating resources to the customer node.

The present invention also discloses a resource management method of a common node communicating with a customer node, including: receiving from the customer node a first weight based on a state of a channel allocated to the customer node and a second weight based on willingness to pay of a user of the customer node; calculating resource cost for the customer node based on the first and the second weights; and controlling the amount of resources required for the customer node to optimize the calculated resource cost and allocating resources to the customer node.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a schematic diagram of a wireless communication network according to an exemplary embodiment of the present invention.

FIG. 2 is a schematic diagram of a resource management system according to an exemplary embodiment of the present invention.

FIG. 3 is a block diagram of a user-driven resource management system according to an exemplary embodiment of the present invention.

FIG. 4 is a block diagram of a service provider-driven resource management system according to an exemplary embodiment of the present invention.

FIG. 5 shows a variety of kinds of resources allocated to each customer node according to an exemplary embodiment of the present invention.

FIG. 6 shows predefined levels of channel state according to an exemplary embodiment of the present invention.

FIG. 7 shows action points based on resource allocation which are predetermined for each channel state according to an exemplary embodiment of the present invention.

FIG. 8 is a flow chart of a user-driven resource management method according to an exemplary embodiment of the present invention.

FIG. 9 is a flow chart of a service provider-driven resource management method according to an exemplary embodiment of the present invention.

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

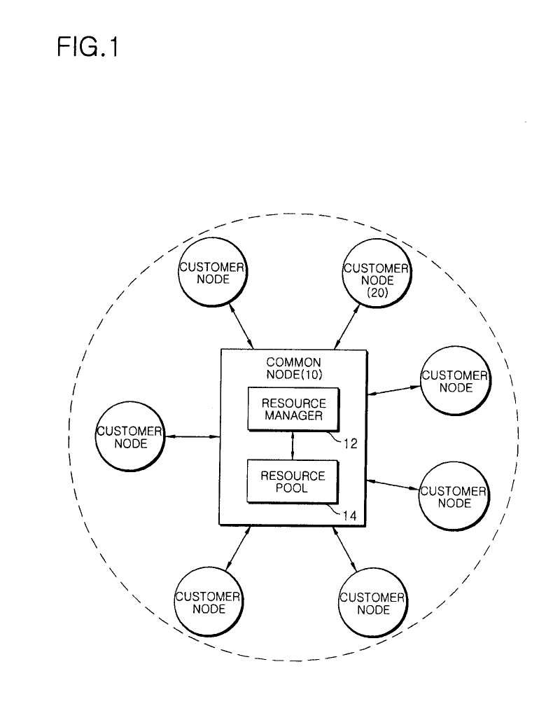

FIG. 1 is a schematic diagram of a wireless communication network according to an exemplary embodiment of the present invention.

The wireless communication network includes a common node 10 (also referred to as access point (AP)), such as base station, and a plurality of customer nodes 20 (also referred to as user terminals).

The common node 10 includes a resource manager 12 and a resource pool 14. The resource pool 14 includes a variety of kinds of resources, such as channel, power, time-slot, route, and packet size. The resource manager 12 distributes the resources to each of the customer nodes 20. The present invention provides a resource management system which efficiently distributes a limited amount of resources of the common node 10 to a plurality of users with fairness and high resource-use rates.

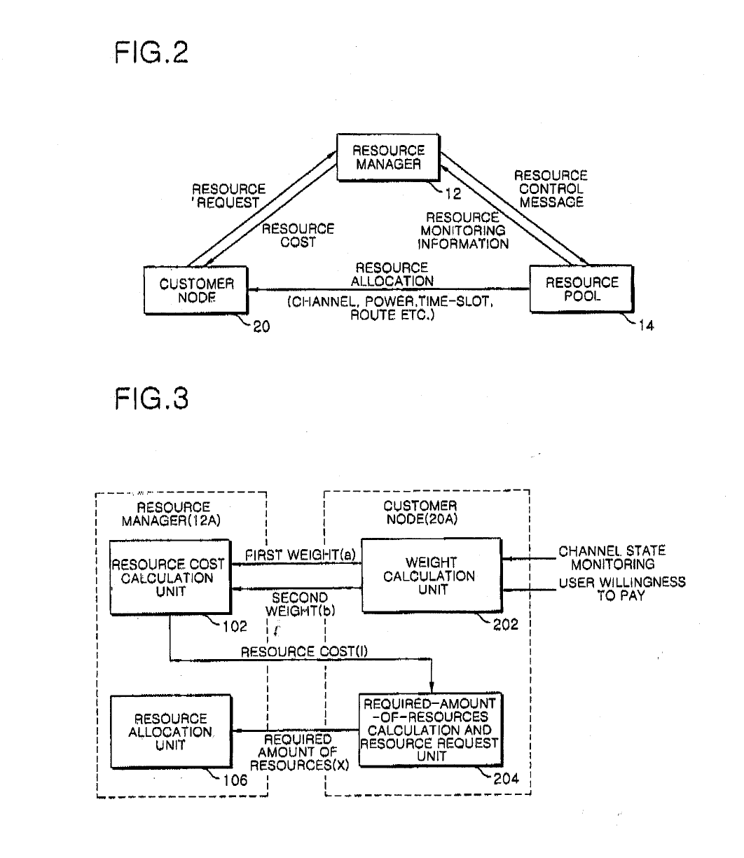

FIG. 2 is a schematic diagram of a resource management system according to an exemplary embodiment of the present invention.

The resource management system includes a resource manager 12 and a customer node 20. With the cooperative work of both of them, the resource management system efficiently allocates various resources of the resource pool 14 to the customer node 20. In other words, at the request of the customer node 20, the resource manager 12 receives resource monitoring information included in the resource pool 14, calculates resource a cost, and allocates resources to the customer node 20 through a resource control message.

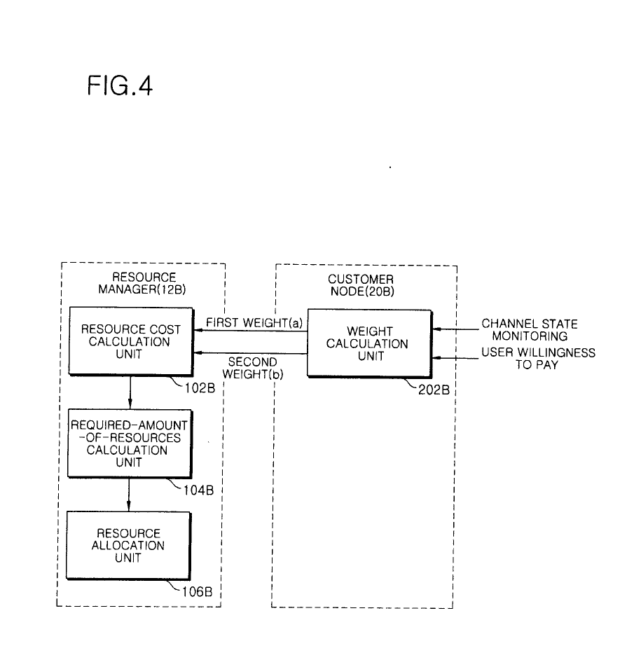

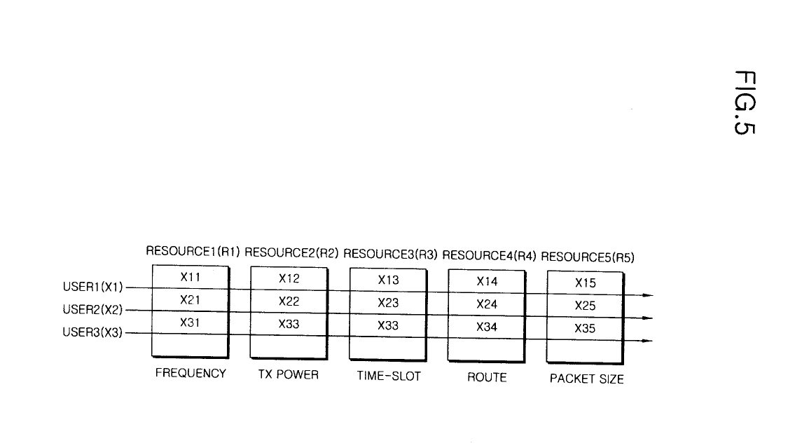

The resource manager 12 and the customer node 20 will be described in more detail with reference to FIGS. 3 and 4.

FIG. 3 illustrates a user-driven resource management system, and FIG. 4 illustrates a service provider-driven resource management system.

FIG. 3 is a block diagram of a user-driven resource management system according to an exemplary embodiment of the present invention.

FIG. 3 illustrates a resource manager 12A and a customer node 20A in a communication system having the common node 10 and the plurality of customer nodes 20 related to the common node 10 as shown in FIG. 1.

The resource manager 12A, which is mounted on the common node 10, includes a resource cost calculation unit 102 and a resource allocation unit 106. The resource cost calculation unit 102 receives from the customer node 20A a first weight (a), based on the state of a channel allocated to each customer node 20A, and a second weight (b), based on willingness to pay of a user of the customer node 20A, and calculates a resource cost (l) of the customer node 20A. When the customer node 20A requests allocation of resources from the resource allocation unit 106 by sending to the resource allocation unit 106 the amount of resources (X) required for optimization of the calculated resource cost (l), the resource allocation unit 106 allocates the resources to the customer node 20A.

The customer node 20A includes a weight calculation unit 202 and a required-amount-of-resources calculation and resource request unit 204. The weight calculation unit 202 calculates a first weight, based on the state of a channel allocated the customer node 20A, and a second weight, based on willingness to pay of a user of the customer node 20A, and transmits the first and the second weights to the common node 10. The required-amount-of-resources calculation and resource request unit 204 receives the resource cost (l) for the customer node 20A, which is calculated based on the first weight (a) and the second weight (b), calculates the amount of resources required for the resource cost optimization, and requests allocation of resources from the common node 10.

The required-amount-of-resources calculation and resource request unit 204 optimizes the received resource cost (l) by requesting the resource allocation unit 106 of the common node 10 to reduce the amount of resources allocated to a customer when the received resource cost (l) of the customer node 10 exceeds a predetermined threshold, and to increase the amount of resources allocated to the customer when the resource cost of the customer node does not exceed a predetermined threshold.

The first weight (a) is for increasing the resource-use rates, and the second weight (b) is for improving fairness between customer node users. The resource cost calculation unit 102 calculates, based on the first weight (a) and the second weight (b), the resource cost for resource optimization for the customer node 20A to increase the resource-use rates and to improve the fairness among customer node users.

In more detail, the first weight (a) indicates a normalization factor which is calculated in advance based on a channel state of the customer node 20A. In one exemplary embodiment of the present invention, the first weight (a) is preferably, but not necessarily, defined as a ratio of a signal-to-noise ratio (SNR) required for a customer node 20A with respect to an SNR required to maintain a bit error rate (BER) of a predetermined reference at the worst channel state.

The second weight (b) indicates a normalization factor which is calculated from a fee based on willingness of customers to pay for a channel. In one exemplary embodiment of the present invention, the second weight (b) is preferably, but not necessarily, defined as the ratio of a fee based on willingness of a user to pay for a channel with respect to a fee based on willingness of all users to pay for the channel.

A detailed definition of the first weight (a) and the second weight (b), a method for calculating the resource cost based on the first weight (a) and the second weight (b), and an algorithm for resource allocation optimization using the resource cost will be described with reference to FIGS. 5 to 7.

FIG. 4 is a block diagram of a service provider-driven resource management system according to an exemplary embodiment of the present invention.

FIG. 4 illustrates a resource manager 12B and a customer node 20B in a communication system having a common node 10 and a plurality of customer nodes 20 related to the common node 10 as shown in FIG. 1.

The resource manager 12B, which is installed at the common node 10, includes a resource cost calculation unit 102B, a required-amount-of-resources calculation unit 104B, and a resource allocation unit 106B. The resource cost calculation unit 102B receives from the customer node 20B a first weight (a), based on the state of a channel allocated to the customer node 20B, and a second weight (b), based on willingness to pay of a user of the customer node 20B, and calculates a resource cost for the customer node 20B based on the first weight (a) and the second weight (b). The required-amount-of-resources calculation unit 104B calculates the amount of resources required for the customer node 20B to optimize the calculated resource cost. The resource allocation unit 106B allocates the calculated amount of resources to the customer node 20B.

The resource allocation unit 106B performs the resource allocation optimization by reducing the amount of resources to be allocated to the customer node 20B when the resource cost of the customer node 20B exceeds a predetermined threshold, and by increasing the amount of resources to be allocated to the customer node 20B when the resource cost of the customer node 20B does not exceed a predetermined threshold.

The customer node 20B includes a weight calculation unit 202B which calculates a first weight (a), based on the state of a channel allocated to the customer node 20B, and a second weight (b), based on willingness to pay of a user of the customer node 20B, and transmits the first weight (a) and the second weight (b) to the common node 20B. The customer node 20B is allocated, from the resource manager 12B of the common node 10, the amount of resources required for the resource cost optimization for the customer node 20B, which is calculated based on the first weight (a) and the second weight (b).

A detailed definition of the first and the second weights, a method for calculating the resource cost based on the first and the second weights, and an algorithm for resource allocation optimization using the resource cost will be described based on the above-mentioned structure of the resource management system.

FIG. 5 illustrates a variety of kinds of resources allocated to each of the customer nodes 20 of FIG. 1 according to an exemplary embodiment of the present invention.

A variety of kinds of resources, such as channel, power, time-slot, route, and packet size, are allocated to the customer nodes 20 through the resource manager 12. The respective resources are denoted by R1, R2, R3, . . . , Rm. The total amount of resources is denoted by Ri. The users of the customer nodes 20 are denoted by U1, U2, U3, . . . , Um. Given that the amount of resources j allocated to a user i is denoted by Xᵢⱼ, the total amount of resources allocated to the user i is expressed by Xᵢ={Xᵢⱼ: j=1, . . . , m}. For instance, referring to FIG. 5, the resource allocated to a user 1 is expressed by X₁={X₁₁, X₁₂, X₁₃, X₁₄, X₁₅}, which is a set of various kinds of resources. Here, the elements X₁₁, X₁₂, X₁₃, X₁₄, and X₁₅ indicate the allocated amount of resources such as channel, power, time-slot, route and packet size, respectively.

In this case, an optimization problem arises from the limited total amount of the respective resources Ri, since it is required to maximize the resource-use rates without sacrificing fairness among the users. In order to solve the optimization problem, the constraints on the resource allocation are expressed by the following equations:

X₁₁+X₂₁+ . . . +Xₙ₁≦R₁

X₁₂+X₂₂+ . . . +Xₙ₂≦R₂

. . .

X₁ₘ+X₂ₘ+ . . . +Xₙₘ≦Rₘ

Under the above constraints, a user of each customer node 20 has an objective equation to maximize his or her resource-use rates, while a service provider of the common node 10 has an objective equation to maximize the sum of resource-use rates of users. The respective objective equations are expressed as follows:
Objective equation of user i: max Ui(Xi)
Objective equation of service provider: max [U1(X1)+U2(X2)+ . . . +Un(Xn)]

In this case, simultaneous optimization is required to satisfy the two different objective equations at the same time. A total number of objective equations is n+1 since all the users have their own objective equations. In this case, a solution to all the objective equations may not exist. However, an approximate solution to the objective equations exists and its ratio is O(log n) as described in “Simultaneous Optimization via Approximate Majorization for Concave Profits or Concave Costs” by Ashish Goel and Adam Meyerson, Sep. 3, 2004 which is incorporated herein by reference.

The above-mentioned approximate solution is obtained by the following two methods: a service provider-driven method and a user-driven method. According to the service provider-driven method, the resource manager 12 collects a user's request and all channel states, obtains an approximate solution to the above-mentioned objective equations, and allocates the approximate solution to a customer node 20. According to the user-driven method, each customer node 20 collects the user's request and all channel states, obtains an approximate solution to the above-mentioned objective equations, requests allocation of required resources from the resource manager 12, and is allocated available resources.

The former method has a disadvantage in that the resource manager 12 should make calculations for a plurality of users, and more resources should be consumed since the resource manager 12 collects data fed back from the customer nodes 20. The latter method risks a chance of obtaining an incorrect solution caused by an arbitrary decision of the customer nodes 20.

The present invention presents a resource-pricing method to solve the above-mentioned problem. According to the resource-pricing method, when the resource manager 12 sets a cost of a resource depending on the current condition of resource use, a user refers to the cost of a resource to be allocated the greatest amount of resources within the range of his or her willingness to pay.

In this case, the cost of resource may be charged either at a direct price for resource use or at a shadow price, i.e., in the form of a penalty imposed on the user or in a reduced resource allocation, which is determined according to communications standards and communications network architecture.

In one exemplary embodiment of the present invention, the resource cost is expressed by the following equation (1):

lᵢ=h*e^{d*Li*a}^{ᵢ}^{/b}^{ᵢ} (1)

Here, Lᵢ indicating a resource load is defined as follows:

$${L}_{i} = {Π}_{k} {\sum }_{j} min \{ {x}_{ik} , {x}_{jk} \} / {R}_{k}$$

The first weight, aᵢ, based on a current channel state of a customer node 20, is a normalization factor calculated in advance, which indicates a SNR to guarantee the user's objective performance (e.g., 100 Mbps). In one exemplary embodiment of the present invention, the first weight, aᵢ, is defined as follows:

aᵢ=SNR required for a user i to maintain a BER of 10⁻³/SNR required to maintain a BER of 10⁻³ at a worst channel state

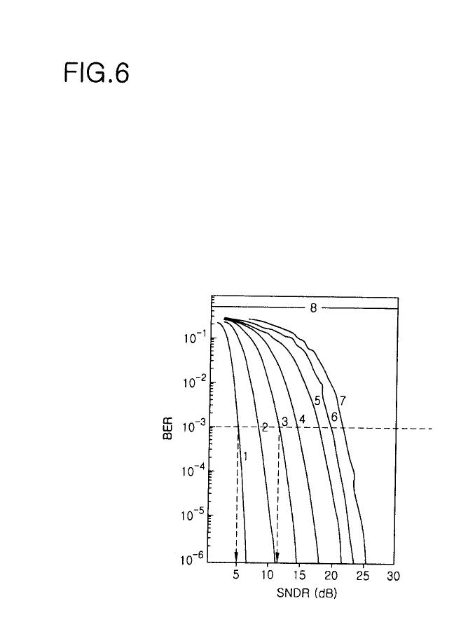

FIG. 6 shows predefined levels of a channel state.

The channel state is divided into 8 levels based on signal-to-noise and distortion ratio (SNDR) and BER. If an SNR of about 5 is required to maintain a BER of 10⁻³ at the worst channel state, a user in a channel state level 3 requires an SNR of about 13 to maintain a BER of 10⁻³. Hence, the first weight aᵢ=13/5=2.6 from the above-mentioned definition of the first weight.

The second weight, bᵢ, based on willingness to pay of a customer node user, is a normalization factor of a fee based on willingness to pay of a user, which is defined as follows:

bᵢ=a fee based on willingness to pay of a user i/total sum of fees based on willingness to pay of all users

Other constants, d and h, are defined as follows:

d=12 log n+2

h=d/2n³e^{d/2n}

where n denotes the number of users.

The resource manager 12 calculates the resource cost lᵢ from the equation (1). If the resource cost lᵢ exceeds a predetermined threshold, the resource manager 12 changes the resource set Xᵢ, which is currently used by a user, to a predetermined lower level according to the aᵢ level. If the resource cost lᵢ does not exceed a predetermined threshold, the resource manager 12 changes the resource set Xᵢ to a predetermined higher level. The predetermined threshold is 1 since the resource cost lᵢ is defined to be 1 when optimized.

In other words, the resource allocation optimization can be achieved based on the resource cost by reducing a currently allocated resource at a resource cost more than 1, which implies that the user is allocated an excessive amount of resources compared to the channel state or user willingness to pay, and by increasing a currently allocated resource at a resource cost not more than 1, which implies that the user is allocated an insufficient amount of resources compared to the user willingness to pay.

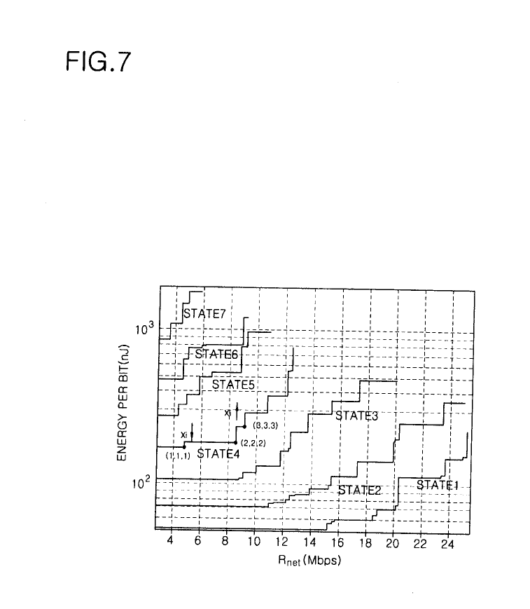

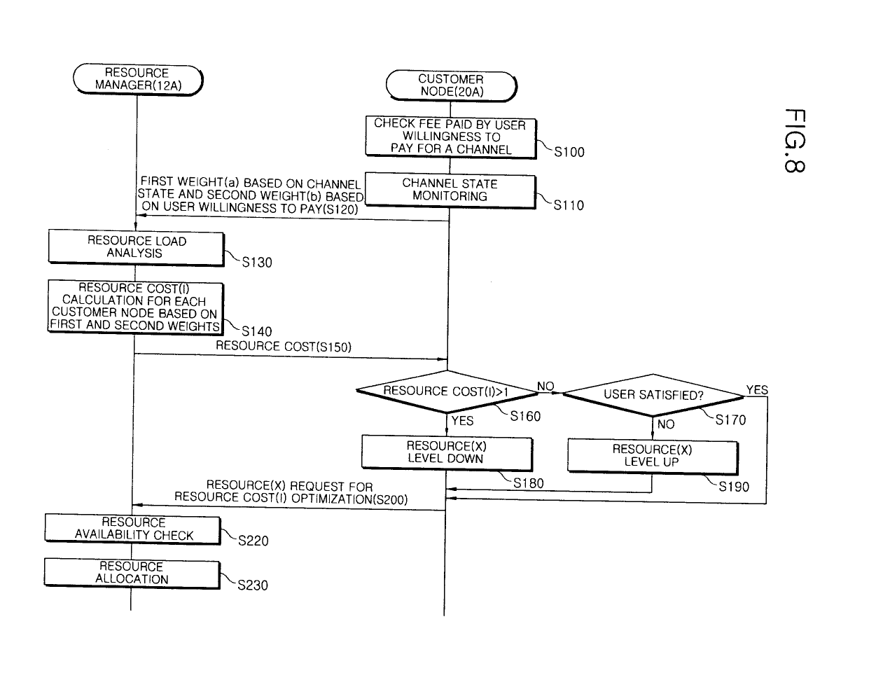

FIG. 7 shows action points based on resource allocation which are predetermined for each channel state. FIG. 7 shows the resource use amount and energy use amount of a customer node for each channel state to suit a user requirement. For example, given that the current resource set is (2, 2, 2) at channel state level 4, the resource allocation may be changed to a predefined higher level, such as resource set (3, 3, 3), or to a predefined lower level, such as resource set (1, 1, 1). Hence, it is possible to easily change the resource allocation so that the resource cost obtained from the equation (1) can be optimized.

As described above, there are two approaches for the resource allocation optimization using the resource cost lᵢ: service provider-driven resource distribution and user-driven resource distribution. The two approaches are implemented according to communications standards and communications network architecture, i.e., according to whether downlink or uplink data transmission is performed, whether or not a channel state feedback scheme is used, whether or not users are forced to feed back actual channel state, or whether direct or shadow pricing mechanism is used.

The above-mentioned algorithm for resource distribution allows a service provider to allocate a larger amount of resources to a customer node which is most profitable rather than to other nodes which are less profitable. In addition, for the users, “user starvation” can be avoided by controlling the amount of resources consumed by his or her customer node.

In other words, supposing that the objective equations of the user i and the service provider are U*ᵢ=max Ui(Xi) and U*ₛₚ=[max U1(X1)+U2(X2)+ . . . +Un(Xn)], respectively, it can be proved that the smallest α satisfying Uᵢ(X)≧U*ᵢ/α and Uₛₚ(X)≧U*ₛₚ/α is at most less than log n/log log n with respect to solution X which is in equilibrium through the above-mentioned algorithm as described in the paper “Pricing for Fairness: Distributed Resource Allocation for Multiple Objectives” by Sung-woo Cho and Ashish Goel, Mar. 12, 2006 which is incorporated herein by reference. Hence, for the user, “user starvation” can be avoided by controlling the amount of resources used by his or her customer node.

For instance, suppose that a time-slot of 50 units is given and the first weights are a₁=0.7 and a₂=0.3 for users 1 and 2, respectively.

If the users 1 and 2 are given first time-slots of 10 and 15, respectively, channel loads L1 and L2 for the users 1 and 2 are 0.2 and 0.3, respectively. Since h=0.0489, the resource costs 11 and 12 for the users 1 and 2 are l₁=0.8788 and l₂=0.3132, respectively.

If the user 1 increases the time-slot to 11, a new resource cost l₁ becomes more than 1. Hence, the user 1 has about 10 to 11 time units.

Similarly, the user 2 is allocated 24 to 25 time units. In this case, it is assumed that the users 1 and 2 have willingness to pay the same fee and want to have unlimited throughput.

As a result, the user 2 with a good channel state is allocated more time units, and the user 1 with a poor channel state is also allocated at least a few time units. Accordingly, it is possible to improve fairness among the users and to prevent “user starvation”, which implies that only a few users are allocated resources.

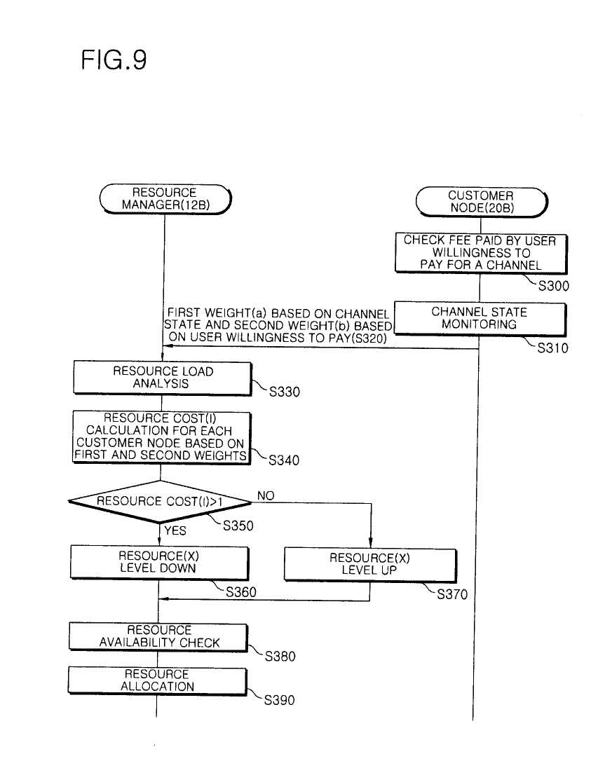

A resource management method using the above-mentioned optimization algorithm will be described. FIG. 8 shows a user-driven resource management method, and FIG. 9 shows a service provider-driven resource management method.

FIG. 8 is a flow chart of a user-driven resource management method according to an exemplary embodiment of the present invention. The method illustrated in FIG. 8 is described below with reference to FIG. 3.

The customer node 20A monitors a channel state and calculates a first weight (a) based on the channel state (S110), checks a fee based on user willingness to pay for a channel and calculates a second weight (b) based on the user willingness to pay (S100), and transmits the first weight (a) and the second weight (b) to the resource manager 12A (S120).

The resource manager 12A analyzes a resource load from the first weight (a) and the second weight (b) (S130), calculates a resource cost (l) for the customer node 20A from the resource load, the first weight (a) and the second weight (b) (S140), and transmits the resource cost (l) to the customer node 20A (S150). The resource cost (l) is calculated from the above-mentioned equation (1).

The customer node 20A compares the resource cost (l) with a predetermined reference 1 to check whether or not it is optimized (S160). If the resource cost is more than 1, the resource (X) is leveled down (S180). If the resource cost is less than 1, the resource (X) is leveled up (S190). Subsequently, the customer node 20A requests allocation of the resource (X) required for resource cost optimization from the resource manager 12A (S200). In this case, if the user is satisfied with the current channel state (S170), no more resource may be allocated to the user even though the resource cost is less than 1.

In other words, the resource allocation optimization can be achieved based on the resource cost (l) by reducing a currently allocated resource at a resource cost more than 1, which implies that the user is allocated an excessive amount of resources compared to the channel state or user willingness to pay, and by increasing a currently allocated resource at a resource cost not more than 1, which implies that the user is allocated an insufficient amount of resources compared to the user willingness to pay.

The resource manager 12A checks the availability of the requested resource (S220), and allocates the resource (S230).

FIG. 9 is a flow chart of a service provider-driven resource management method according to an exemplary embodiment of the present invention.

The service provider-driven resource management method is similar to the above-mentioned user-driven method except that the resource allocation optimization based on the resource cost (operations S160 to S190 of FIG. 8 in case of the user-driven method; operations S350 to S370 of FIG. 9 in case of the service provider-driven method) is performed by the customer node 20A in case of the user-driven method but by the resource manager 12B in case of the service provider-driven method.

As apparent from the above description, the present invention provides a method and system for managing resources, which is capable both of increasing resource-use rates to allow service providers to maximize profits and of allocating the resources to users with improved fairness.

The present invention further provides a method for managing resources through a resource distribution algorithm which induces users to willingly increase the resource-use rates.

In other words, the present invention provides an algorithm for resource cost optimization, which defines the first weight for higher resource-use rates, based on the state of a channel allocated to each customer node, and the second weight for improved fairness among users, based on willingness of a user of each customer node to pay, calculates the resource cost for each customer node from the first and the second weights, and controls resource allocation for resource cost optimization.

As a result, it is possible to improve both resource-use rates and user fairness, to provide an efficient resource management system which allows users to willingly increase the resource-use rates, and to prevent “user starvation”.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A resource manager of a common node communicating with at least one customer node, comprising:
a cost calculation unit which receives from a customer node among the at least one customer node a first weight based on a state of a channel allocated to the customer node and a second weight based on willingness to pay of a user of the customer node, and calculates a resource cost for the customer node; and
a resource allocation unit which receives from the customer node a resource allocation request for optimization of the resource cost and allocates at least one resource to the customer node.

2. The resource manager of claim 1,
wherein the first weight is for increasing resource-use rates,
the second weight is for improving fairness among users of the at least one customer node, and
the cost calculation unit calculates based on the first and the second weights the resource cost for resource optimization for each of the at least one customer node to increase the resource-use rates and to improve the fairness among the users of the at least one customer node.

3. The resource manager of claim 1, wherein the first weight is a normalization factor calculated in advance based on the state of the channel allocated to the customer node.

4. The resource manager of claim 1, wherein the first weight is defined as a ratio of a signal-to-noise ratio (SNR) required for the customer node with respect to an SNR required to maintain a bit error rate (BER) of a predetermined reference at a worst state of the channel.

5. The resource manager of claim 1, wherein the second weight is a normalization factor calculated from a fee based on willingness of the user of the customer node to pay for the channel.

6. The resource manager of claim 1, wherein the second weight is defined as a ratio of a fee based on willingness of the user of the customer node to pay for the channel with respect to a fee based on willingness of users of the at least one customer node to pay for the channel.

7. A customer node communicating with a common node, comprising:
a weight calculation unit which calculates a first weight based on a state of a channel allocated to the customer node, and a second weight based on willingness to pay of a user of the customer node, and transmits the first and the second weights to the common node; and
a resource request unit which receives from the common node a resource cost for the customer node calculated based on the first and the second weights, calculates an amount of resources required for optimization of the resource cost, and requests allocation of at least one resource from the common node.

8. The customer node of claim 7, wherein the resource request unit optimizes the resource cost by requesting the common node to reduce the amount of resources allocated to the customer node if the resource cost for the customer node exceeds a predetermined threshold, and by requesting the common node to increase the amount of resources allocated to the customer node if the resource cost does not exceed a predetermined threshold.

9. The customer node of claim 7,
wherein the first weight is for increasing resource-use rates,
wherein the second weight is for improving fairness among users of at least one customer node communicating with the common node including the user of the customer node which is one of the at least one customer node, and
wherein the resource request unit receives from the common node the resource cost for the customer node calculated based on the first and the second weights for resource optimization for each of the at least one customer node to increase the resource-use rates and to improve the fairness among the users of the at least one customer node.

10. The customer node of claim 7, wherein the first weight is a normalization factor calculated in advance based on the state of the channel.

11. The customer node of claim 7, wherein the first weight is defined as a ratio of a signal-to-noise ratio (SNR) required for the customer node with respect to an SNR required to maintain a bit error rate (BER) of a predetermined reference at a worst state of the channel.

12. The customer node of claim 7, wherein the second weight is a normalization factor calculated from a fee based on willingness of the user of the customer node to pay for the channel.

13. The customer node of claim 7, wherein the second weight is defined as a ratio of a fee based on willingness of the user of the customer node to pay for the channel with respect to a fee based on willingness of users of at least one customer node communicating with the common node including to pay for the channel.

14. A resource manager of a common node communicating with at least one customer node, comprising:
a cost calculation unit which receives from a customer node among the at least one customer node a first weight based on a state of a channel allocated to the customer node and a second weight based on willingness to pay of a user of the customer node, and calculates a resource cost for the customer node; and
a resource allocation unit which calculates an amount of resources required for the customer node for optimization of the resource cost and allocate at least one resource to the customer node.

15. The resource manager of claim 14, wherein the resource allocation unit optimizes the resource cost by reducing the amount of resources allocated to the customer node if the resource cost for the customer node exceeds a predetermined threshold, and by increasing the amount of resources allocated to the customer node if the resource cost does not exceed a predetermined threshold.

16. The resource manager of claim 14,
wherein the first weight is for increasing resource-use rates,
the second weight is for improving fairness among users of the at least one customer node, and
the cost calculation unit calculates based on the first and the second weights the resource cost for resource optimization for each of the at least on customer node to increase the resource-use rates and to improve the fairness among the users of the at least one customer node.

17. The resource manager of claim 14, wherein the first weight is a normalization factor calculated in advance based on the state of the channel.

18. The resource manager of claim 14, wherein the first weight is defined as a ratio of a signal-to-noise ratio (SNR) required for the customer node with respect to an SNR required to maintain a bit error rate (BER) of a predetermined reference at a worst state of the channel.

19. The resource manager of claim 14, wherein the second weight is a normalization factor calculated from a fee based on willingness of the user of the customer node to pay for the channel.

20. The resource manager of claim 14, wherein the second weight is defined as a ratio of a fee based on willingness of the user of the customer node to pay for the channel with respect to a fee based on willingness of users of the at least one customer node to pay for the channel.

21. A customer node communicating with a common node, comprising:
a weight calculation unit which calculates a first weight based on a state of a channel allocated to the customer node, and a second weight based on willingness to pay of a user of the customer node, and transmits the first and the second weights to the common node,
wherein the customer node is allocated from the common node an amount of resources required for optimization of a resource cost for the customer node calculated based on the first and the second weights.

22. The customer node of claim 21,
wherein the first weight is for increasing resource-use rates,
wherein the second weight is for improving fairness among users of at least one customer node communicating with the common node including the user of the customer node which is one of the at least one customer node, and
wherein the customer node uses at least one resource allocated based on the resource cost for the customer node calculated based on the first and the second weights for resource optimization for each of the at least one customer node to increase the resource-use rates and to improve the fairness among the users of the at least one customer node.

23. The customer node of claim 21, wherein the first weight is a normalization factor calculated in advance based on the state of the channel.

24. The customer node of claim 21, wherein the first weight is defined as a ratio of a signal-to-noise ratio (SNR) required for the customer node with respect to an SNR required to maintain a bit error rate (BER) of a predetermined reference at a worst state of the channel.

25. The customer node of claim 21, wherein the second weight is a normalization factor calculated from a fee based on willingness of the user of the customer node to pay for the channel.

26. The customer node of claim 21, wherein the second weight is defined as a ratio of a fee based on willingness of the user of the customer node to pay for the channel with respect to a fee based on willingness of users of the at least one customer node to pay for the channel.

27. A resource management method of a common node communicating with at least one customer node, comprising:
receiving from a customer node among the at least one customer node a first weight based on a state of a channel allocated to the customer node and a second weight based on willingness to pay of a user of the customer node;
calculating a resource cost for the customer node based on the first and the second weights, and transmitting the resource cost to the customer node; and
receiving from the customer node a resource allocation request for optimization of the resource cost, and allocating at least one resource to the customer node.

28. The resource management method of claim 27, wherein allocating the at least one resource comprises optimizing the calculated resource cost by reducing an amount of resources allocated to the customer node if the resource cost for the customer node exceeds a predetermined threshold, and by increasing the amount of resources allocated to the customer node if the resource cost does not exceed a predetermined threshold.

29. A resource management method of a common node communicating with at least one customer node, comprising:
receiving from a customer node among the at least one customer node a first weight based on a state of a channel allocated to the customer node and a second weight based on willingness to pay of a user of the customer node;
calculating a resource cost for the customer node based on the first and the second weights; and
controlling an amount of resources required for the customer node to optimize the calculated resource cost and allocating at least one resource to the customer node.

30. The resource management method of claim 29, wherein allocating the at least one resource comprises optimizing the calculated resource cost by reducing an amount of resources allocated to the customer node if the resource cost for the customer node exceeds a predetermined threshold, and by increasing the amount of resources allocated to the customer node if the resource cost does not exceed a predetermined threshold.
